(19) United States
(12) Patent Application Publication
(10) Pub. No.: US 2007/0272524 A1
(43) Pub. Date: Nov. 29, 2007

(54) Rotary Switch in a Motor Vehicle

(76) Inventors: Juergen Girke, Reichenau (DE); Klaus Mueller, Aach (DE); Josef Ferstl, Saal (DE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/571,632

(22) PCT Filed: Sep. 15, 2004
(86) PCT No.: PCT/EP04/10357

§ 371 Date: Mar. 6, 2007

(30) Foreign Application Priority Data
Sep. 16, 2003 (DE) 203 14 364.7

(51) Int. Cl. H01H 19/10; H01H 9/16; H01H 9/18

(52) U.S. Cl. 200/11 DA; 200/11 R

(57) ABSTRACT

A rotary switch in a motor vehicle comprises a stationary central part and a rotatable outer part. To the rotatable outer part a control part is coupled, which transfers the rotary movement of the outer part directly into a contact unit (16).

The invention relates to a rotary switch in a motor vehicle, comsng a stationary central part and a rotatable outer part.

Rotary switches in motor vehicles for the selection of particular functions, such as for example light functions (high beams, low beams, parking light etc.) are generally constructed as rotary knobs with a projecting grip part, which are arranged in an operating panel on the dashboard. The rotary knobs are provided with a marking which is directed to a symbol corresponding to the desired function. Further, rotary switches having a rotatable outer ring are known, which are used, for example, in operating panels of air-conditioning systems. In such rotary switches, the rotary movement of the outer ring is transferred via toothed wheels to a switching unit or a contact unit, which requires a high expenditure in terms of parts and leads to high cumulative tolerances.

The invention provides a rotary switch, in which the cumulative tolerances and also the structural space are reduced.

In a rotary switch of the type initially mentioned, this is achieved according to the invention in that a control part is coupled to the rotatable outer part, which control part transfers the rotary movement of the outer part directly into a contact unit. Such a rotary switch can be realized with a very low overall height, because no grip part is necessary. Owing to the direct introduction of the rotary movement into the contact unit by means of a single component, complicated constructions with toothed wheels or the like can be dispensed with. Especially rotary switches according to the invention used for the controlling of the light functions in a motor vehicle do not require an illumination of the outer part (with the exception of a possible marking being provided) when the function symbols are arranged in the stationary central part, so that substantially any desired material can be selected for the components of the outer part.

Advantageous and expedient developments of the rotary switch according to the invention are indicated in the sub-claims.

Further features and advantages of the invention will be apparent from the following description of an example embodiment and from the enclosed drawings to which reference is made. In the drawings:

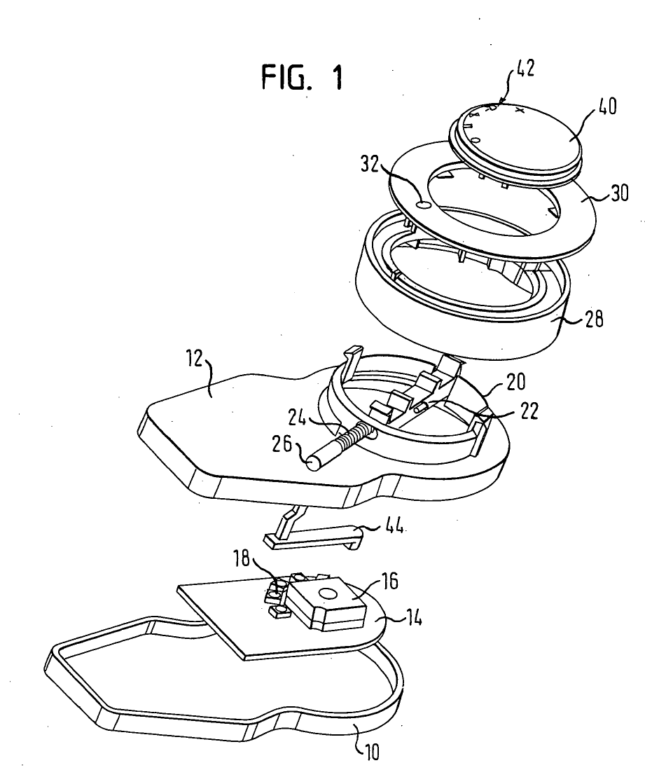

FIG. 1 shows an exploded view of a rotary switch according to the invention;

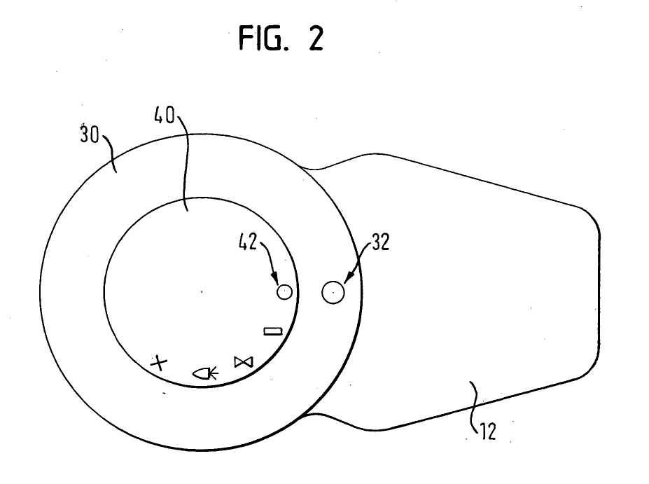

FIG. 2 shows a top view of the rotary switch;

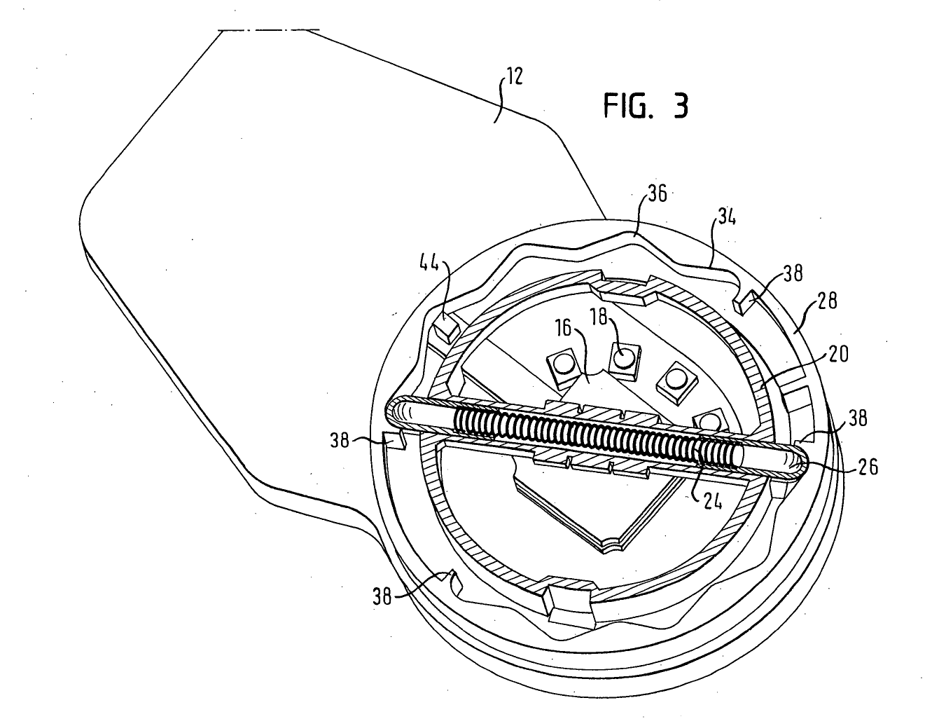

FIG. 3 shows a perspective top view of the rotary switch without cover and rotary ring; and

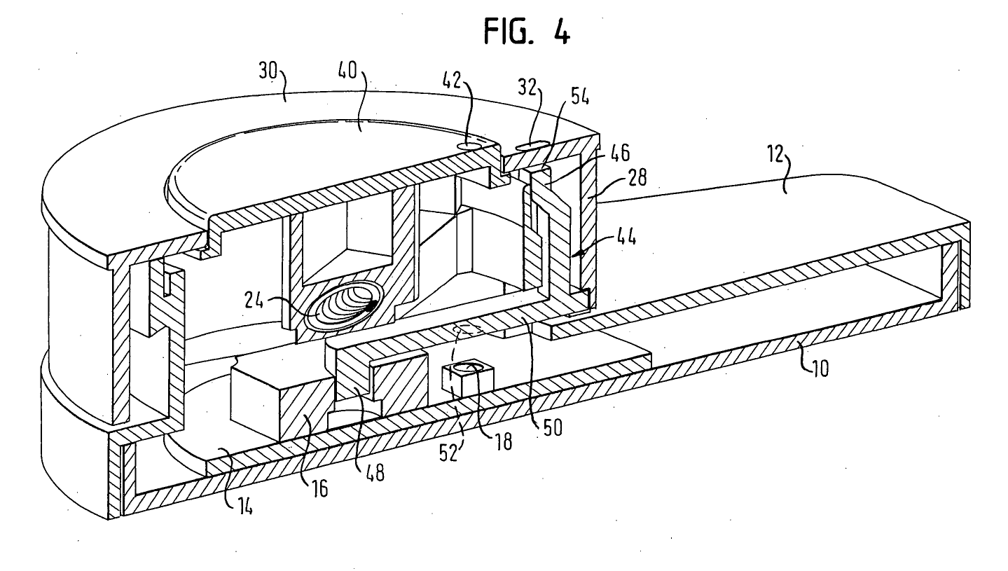

FIG. 4 shows a perspective sectional view of the rotary switch.

In FIGS. 1 to 4, a rotary switch according to the invention is illustrated, which is provided for selecting the light functions in a motor vehicle. The rotary switch comprises lower and upper housing parts 10 and 12, respectively, between which a printed circuit board 14 is held, with a contact unit 16 and several light-emitting diodes 18. The upper housing part 12 has a housing ring part 20 with a diametrical guide 22, in which a helical spring 24 is held (see FIG. 3). At the two ends of the spring 24, detent pins 26 are arranged, which project radially from the housing ring part 20.

Extending around the housing ring part 20 is an outer ring 28, which is clipped onto the housing ring part 20 but is rotatable with respect thereto. A rotary ring 30 with a transparent marking 32 is fitted axially onto the outer ring 28. The outer ring 28 and the rotary ring 30 together form a rotatable outer portion of the rotary switch. In FIG. 3 it can be seen that the outer ring 28 has an undulating inner contour 34. The detent pins 26 are pressed against the undulating contour 34 through the spring 24. The undulation troughs 36 of the inner contour 34 thus form stable detent positions in case of a rotation of the outer ring 28, in which the spring 24 relaxes, as shown in FIG. 3. A detent position is provided for each function which is able to be controlled with the switch. The undulating contour 34 also has end stops 38, which delimit the rotation of the outer ring 28.

A cover 40 engaging behind the rotary ring 32 is securely connected by clip connections with the housing ring part 20 and forms together therewith a central part of the switch which is stationary with respect to the rotatable outer region. The cover 40 has several transparent symbols 42, which represent the various light functions. The rotary switch further comprises a photoconductor lever 44, provided with mirror surfaces on its inside, which is clipped with a first end 46 on the outer ring 28. The second end 48 of the photoconductor lever engages into the contact unit 16 for controlling a sliding contact. In a cross-section 50 of the photoconductor lever 44, on its lower side opposite the printed circuit board 14, a light inlet opening 52 is provided, which is only indicated diagrammatically in FIG. 4. At the first end 46 of the photoconductor lever 44, a light outlet opening 54 is formed, located opposite the marking 32 of the rotary ring 30.

The mode of operation of the rotary switch is described below. The user selects one of the functions illustrated symbolically on the cover 40, by turning the outer ring 28 relative to the stationary cover 40 into a detent position, in which the marking 32 of the co-rotated rotary ring 30 lies opposite the desired symbol 42. The detent mechanism, formed by the outwardly prestressed detent pins 26 and the inner contour 34 of the outer ring 28, gives the user here a responsive feel. The rotary movement is introduced directly into the contact unit 16 via the photoconductor lever 44. Via the second end 48 of the photoconductor lever 44, a sliding contact or the like is moved in the contact unit 16, which in the detent position produces the corresponding contact connection for the selected light function.

The symbols 42 in the cover 40 are permanently illuminated by the light-emitting diodes 18 arranged on the printed circuit board 14. The illumination of the marking 32 on the rotary ring 30 is carried out with the aid of the photoconductor lever 44. The light of the light-emitting diodes 18, which are situated under the transverse section 50 of the photoconductor lever 44, is coupled via the light inlet opening 52 into the photoconductor lever 44 and, with the aid of the inside mirror surfaces, is directed to the first end 46 of the photoconductor lever 44. There, the light emerges from the light outlet opening 54 and impinges on the marking 32. Instead of the mirror surfaces, a photoconducting cable or the like can also be provided. The photoconductor lever 44 therefore has a dual function. Firstly, it serves as a control part which introduces the rotary movement of the outer part of the switch directly into the contact unit 16; secondly, it provides a photoconducting path, via which the light of the light-emitting diodes 18 is directed to the marking 32.

The rotary switch according to the invention was described with the aid of an actual example embodiment in the form of a rotary light switch in a motor vehicle, but is basically also suitable for other applications, in particular in the motor vehicle field.

1. A rotary switch in a motor vehicle, comprising a stationary central part and a rotatable outer part, characterized in that to the rotatable outer part a control part is coupled, which transfers the rotary movement of the outer part directly into a contact unit (16).

2. The rotary switch according to claim 1, characterized in that on the central part symbols (42) are arranged, which represent the functions able to be selected with the switch, and on the outer part a marking (32) is arranged.

3. The rotary switch according to claim 2, characterized in that the control part includes a photoconducting path, via which the light of a light source is directed to the marking (32).

4. The rotary switch according to claim 3, characterized in that the control part is an at least partially hollow lever (44) having a light inlet opening (52) and a light outlet opening (54).

5. The rotary switch according to claim 4, characterized in that the lever (44) has inside mirror surfaces.

6. The rotary switch according to any of the preceding claims, characterized in that the outer part is formed by an outer ring (28) and an axially fitted rotary ring (30), on which the marking (32) is arranged, and that the central part includes a cover (40), on which the symbols (42) are arranged.

7. The rotary switch according to claim 6, characterized in that the symbols (42) are transparent and the rotary switch comprises a housing (10, 12), in which light-emitting diodes (18) are arranged for illuminating the symbols (42).

8. The rotary switch according to claim 4 and claim 7, characterized in that the lever (44) is arranged so that the light of the light-emitting diodes (18) impinges on its light inlet opening (52).

9. The rotary switch according to claim 7 or 8, characterized in that in the housing (10, 12) a printed circuit board (14) is held, on which the contact unit (16) and the light-emitting diodes (18) are arranged.

10. The rotary switch according to any of the preceding claims, characterized in that the control part is coupled to a sliding contact in the contact unit (16).

11. The rotary switch according to any of the preceding claims, characterized in that the rotary switch comprises a detent mechanism with at least one radially outwardly prestressed detent pin (26) coupled to the central part and an inner contour (34) formed in the outer part, which defines detent sites for the detent pin (26).
